(19) United States
(12) Patent Application Publication
(10) Pub. No.: US 2015/0084851 A1
(43) Pub. Date: Mar. 26, 2015

(54) ELECTRONIC DEVICE HAVING PLURALITY OF HUMAN-MACHINE OPERATION MODULES

(71) Applicant: Atrust Computer Corp., Taoyuan County (TW)

(72) Inventors: HOE-TO CHO, Taoyuan County (TW); YA-FU WEI, Taoyuan County (TW); SHIH-CHEN SUN, Taoyuan County (TW); YI-CHYN YEN, Taoyuan County (TW)

(73) Assignee: Atrust Computer Corp., Taoyuan County (TW)

(21) Appl. No.: 14/230,609

(22) Filed: Mar. 31, 2014

(30) Foreign Application Priority Data
Sep. 24, 2013 (TW) 102134288

(51) Int. Cl. G06F 3/01

(52) U.S. Cl. CPC G06F 3/01
USPC 345/156

(57) ABSTRACT

An electronic device having a plurality of human-machine operation modules is disclosed. The electronic device is internally provided with at least one I/O module and a plurality of human-machine operation modules disposed in the electronic device, several human-machine operation modules being connected with the I/O module respectively.

### CROSS-REFERENCE TO RELATED APPLICATION

This application claims the benefit of Taiwan Patent Application No. 102134288, filed on Sep. 24, 2013, which is hereby incorporated by reference for all purposes as if fully set forth herein.

### BACKGROUND OF THE INVENTION

1. Field of the Invention

The present invention relates to an electronic device having a plurality of human-machine operation modules, and more particularly to an electronic device of a plurality of human-machine interfaces connected with input/output (I/O) module respectively.

2. Related Art

In the prior art, to increase the performance of the electronic device, researchers develop the technology that one machine is operated by multiple users, i.e., the same electronic device may simultaneously provide multiple operation platforms to different users. However, such an electronic device still has a single human-machine interface, generates multiple software working platforms only through software functions, coordinates with an extension component additionally set to correspond to each software working platform, to achieve that one machine is operated by multiple users, instead of making users have independent human-machine interface on the hardware.

### SUMMARY OF THE INVENTION

A technical objective of the present invention lies in providing an electronic device having a plurality of human-machine operation modules.

The electronic device according to the present invention includes at least one I/O module and a plurality of human-machine operation modules, wherein each human-machine operation module is disposed in the electronic device, and several human-machine operation modules are connected with the I/O module respectively.

The present invention has the following characteristics, (1) through hardware configurations of a plurality of human-machine operation modules, different users can use corresponding human-machine operation modules by means of hardware operation; (2) the technology in the present invention is applicable to various electronic devices having data computing capability, for example, Desktop PC, mini PC, thin client PC, or electronic devices without data computing capability, for example, zero client device, and thus has higher applicability.

### BRIEF DESCRIPTION OF THE DRAWINGS

FIG. 1A illustrates a first structure block diagram of an embodiment of an electronic device according to the present invention;

FIG. 1B illustrates a first hardware exterior view of an embodiment of the electronic device according to the present invention;

FIG. 2A illustrates a second structure block diagram of an embodiment of the electronic device according to the present invention;

FIG. 2B illustrates a second hardware exterior view of an embodiment of the electronic device according to the present invention;

FIG. 2C illustrates another embodiment of the second structure block diagram of the electronic device according to the present invention;

FIG. 3 illustrates a third structure block diagram of an embodiment of the electronic device according to the present invention;

FIG. 4 illustrates a fourth structure block diagram of an embodiment of the electronic device according to the present invention;

FIG. 5A illustrates a fifth structure block diagram of an embodiment of the electronic device according to the present invention; and

FIG. 5B illustrates a third hardware exterior view of an embodiment of the electronic device according to the present invention.

### DETAILED DESCRIPTION OF THE EMBODIMENTS

Preferred embodiments of the present creation are further described below with reference to the drawings.

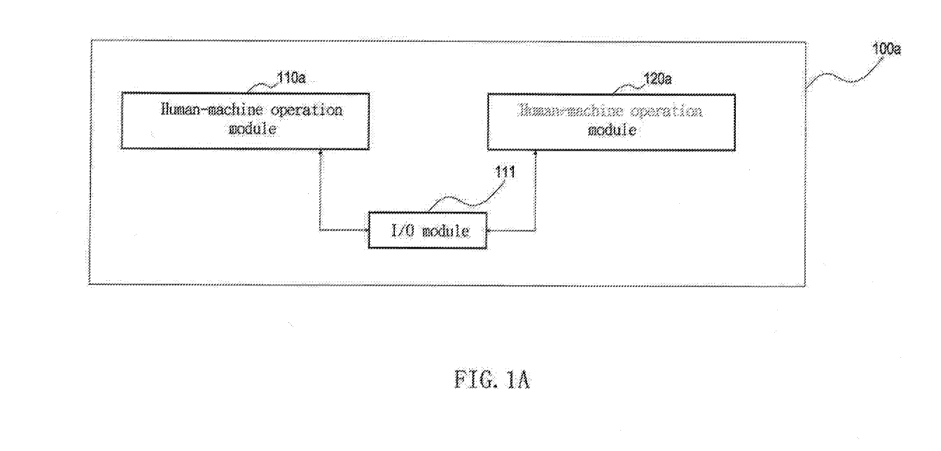

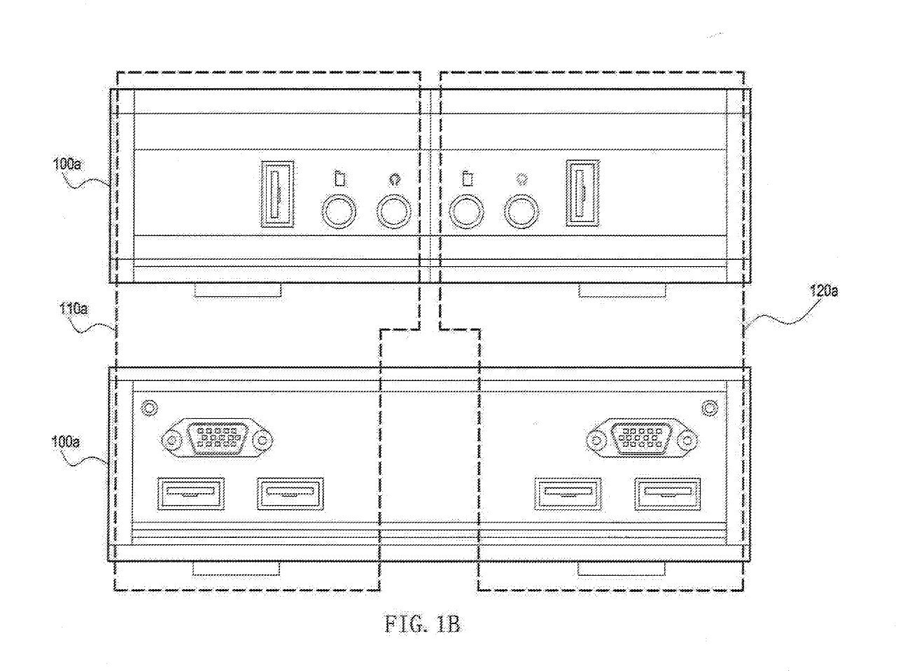

First, FIG. 1A illustrates a first structure block diagram of an embodiment of an electronic device according to the present invention, and FIG. 1B illustrates a first hardware exterior view of an embodiment of the electronic device according to the present invention.

The electronic device includes more than one I/O module (I/O module) and a plurality of human-machine operation modules (Human-Machine Interface). The number of the human-machine operation modules that can be configured by the electronic device may be more than two, each human-machine operation module is disposed in the electronic device, and is connected with the I/O module respectively, and operation panel configurations of each human-machine operation module may be of the same type or different types, which depends on demands of the designer. In addition, each human-machine operation module should be designed to have an output unit, such as an indicator signal or an audible indicator. However, the type and the configuration manner of the output unit depend on demands of the designer, which are not limited.

The electronic device 100a in this embodiment is described with two human-machine operation modules (110a, 120a) and one I/O module 111 for the time being, but is not limited thereto. As stated previously, several human-machine operation modules (110a, 120a) are connected with the I/O module 111. The I/O module 111 processes message input and output operations of a target operation module, which has been started, of the human-machine operation modules (110a, 120a).

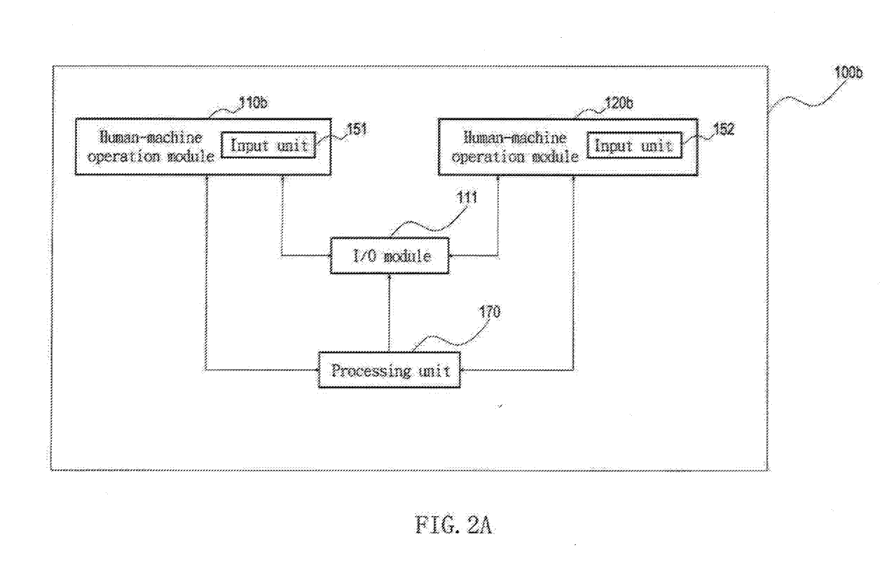

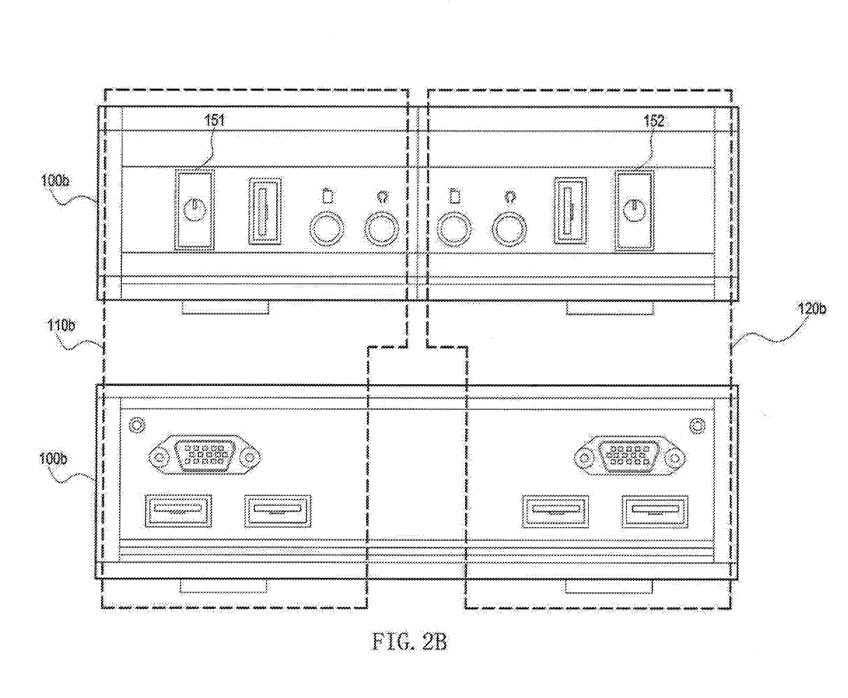

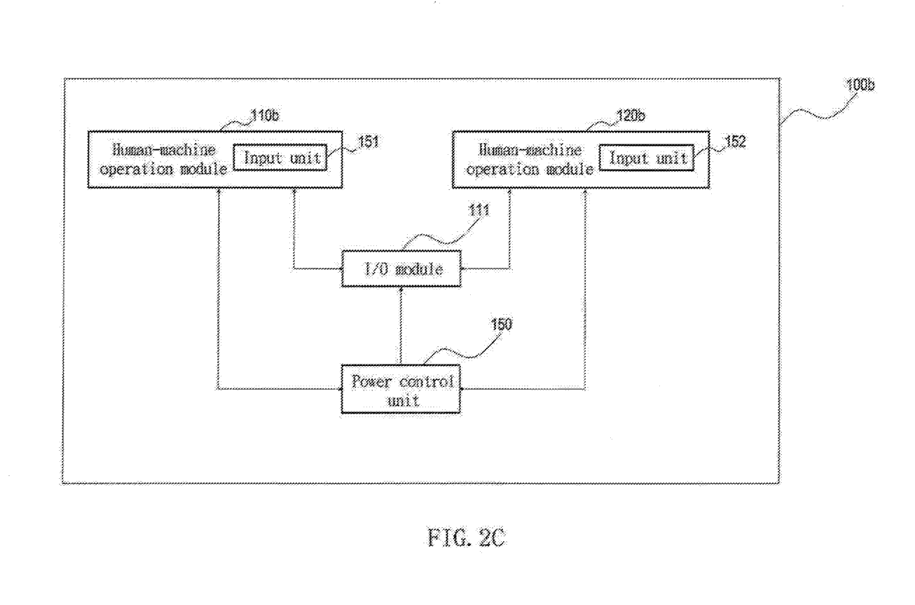

FIG. 2A illustrates a second structure block diagram of an embodiment of the electronic device according to the present invention, FIG. 2B illustrates a second hardware exterior view of an embodiment of the electronic device according to the present invention, and FIG. 2C illustrates another embodiment of the second structure block diagram of the electronic device according to the present invention. Different from the previous embodiments, human-machine operation modules (110b, 120b) each have input units (151, 152). The input units (151, 152) are both connected to a processing unit 170. When the input unit of a target operation module of all the human-machine operation modules (110b, 120b) is operated, the processing unit 170 may, according to the manner in which the input unit is operated, or mechanical acts input due to operations, or electrical signals generated due to operations, decide whether to start the target operation module. For example, the human-machine operation module 120b is used by a user, and the human-machine operation module 120b is regarded as the target operation module. When the input unit 152 is operated, the processing unit 170 judges that the input unit 152 conforms to the manner in which the human-machine operation module 120b is operated, or when an electrical signal output by the input unit 152 conforms to a start condition of the human-machine operation module 120b, the processing unit 170 starts the human-machine operation module 120b. In some embodiments, the input units (151, 152) may be switches (as shown in FIG. 2B), and when the processing unit 170 judges that the switch of the target operation module is turned on, the target operation module is started. Alternatively, in other embodiments, the input units (151, 152) are remote controls, and when the processing unit 170 judges that the key of the controller of the target operation module is pressed in a specific manner, the target operation module is started. Also, the input units (151, 152) may be keyboards, and when the processing unit 170 judges that the key of the keyboard of the target operation module is pressed in a specific manner, the target operation module is started. Also, the input units (151, 152) may be mice, and when the processing unit 170 judges that the mouse of the target operation module is manipulated, the target operation module is started. Further, the input units (151, 152) may be touch screens, and when the processing unit 170 judges that the touch screens are pressed or clicked, the target operation module is started. Moreover, the input units (151, 152) may be electronic authentication devices having capability of reading identity authentication data or biological characteristics to identify identity, such as card readers, fingerprint readers, voiceprint machines, or chip authentication devices. When the processing unit 170 judges that the authentication data read by the electronic authentication device of the target operation module is qualified, the target operation module is started. In some embodiments, the input units (151, 152) are a combination of at least one of the electronic authentication devices, the keyboards, the mice, the switches and the touch screens, and when the processing unit 170 judges that the input units (151, 152) are operated in a specific manner, the target operation module is started. The switches may be elements having capability of setting a state, switching, triggering or sensing (e.g., sound sensitive, light sensitive, pressure sensitive), but are not limited thereto, and elements, modules, circuits or devices having similar functions are also applicable.

Referring to FIG. 2C, in some embodiments, the electronic device 100b further includes a power control unit 150, and when the input units (151, 152) of the target operation module are operated, the target operation module is started by obtaining power of the power control unit 150 connected thereto. For example, the human-machine operation module 120b is used by a user, and the human-machine operation module 120b is regarded as the target operation module. When the input unit 152 is operated, the human-machine operation module 120b is started by obtaining power of the power control unit 150.

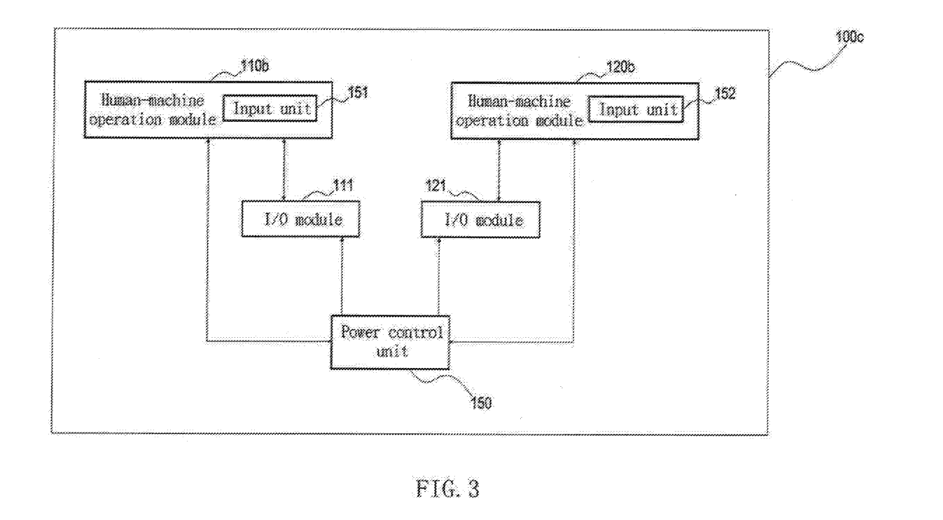

FIG. 3 illustrates a third structure block diagram of an embodiment of the electronic device according to the present invention. The embodiment differs from the previous embodiments in that the electronic device 100c includes multiple I/O modules (111, 121). Each human-machine operation module (110b, 120b) connects one of the multiple I/O modules (111, 121), and each I/O module processes message input and output operations of the human-machine operation module connected thereto. For example, if the human-machine operation module 110b connects the I/O module 111 and the human-machine operation module 120b connects the I/O module 121, the I/O module 111 processes message input and output operations of the human-machine operation module 110b connected thereto and the I/O module 121 processes message input and output operations of the human-machine operation module 120b connected thereto.

The power control unit 150, in addition to connecting the human-machine operation modules (110b, 120b), connects the I/O modules (111, 121). The power control unit 150 provides power for an I/O module connected to a target operation module while providing power for the target operation module. For example, the target operation module is the human-machine operation module 110b, and the power control unit 150 provides power for the I/O module 111 connected to the human-machine operation module 110b while providing power for the human-machine operation module 110b.

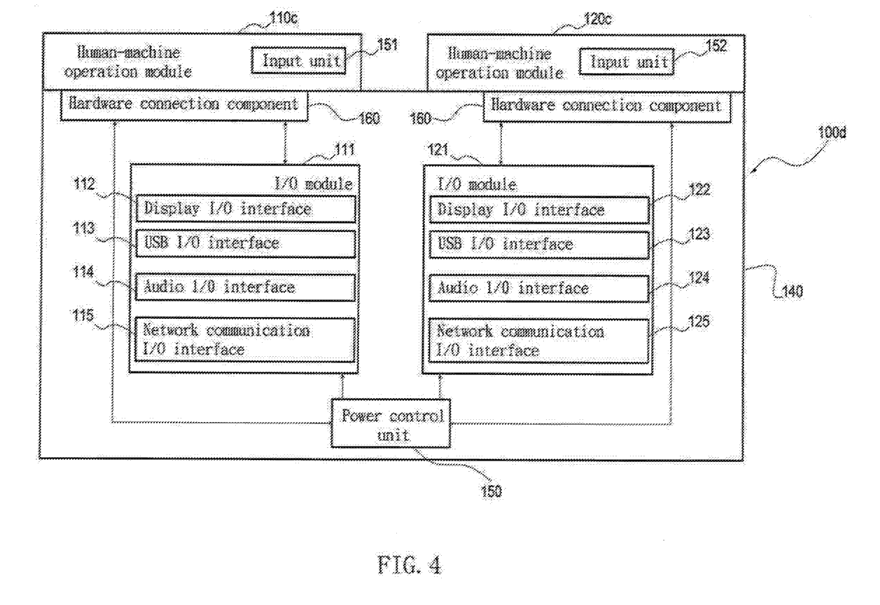

In some embodiments, the human-machine operation modules may be detachable hardware components, for example, detachable panel components. For ease of description, a block diagram is used below for description. FIG. 4 illustrates a fourth structure block diagram of an embodiment of the electronic device according to the present invention, to facilitate understanding.

The electronic device 100d includes a body 140 and human-machine operation modules (110c, 120c). The human-machine operation modules (110c, 120c) are mounted to or removed from the body 140 through a hardware connection component 160, for example, a combination of a connection joint and a connection socket, so as to be mounted on or removed from the body 140. When the human-machine operation modules (110c, 120c) are assembled to hardware, they may be connected with the power control unit 150.

In some embodiments, the human-machine operation modules store permission information internally, and when the I/O modules connect a target operation module of the human-machine operation modules, a corresponding function is started according to interface information of the target operation module.

By taking FIG. 4 as an example, the body 140 includes two I/O modules (111, 121), and each of the I/O modules (111, 121) includes I/O modules of the same type. Each of the I/O modules (111, 121) has a display I/O interface ((112, 122), e.g., Display Port, D-sub, DVI, or HDMI), a universal serial bus I/O interface (USB I/O interface) (113, 123), an audio I/O Interface (114, 124), a network communication I/O interface (115, 125) and other types of interfaces.

Various types of I/O interfaces are used for connecting operation devices (Control Device) corresponding to the interfaces. For example, the display I/O interface (112, (22) connects a display (Monitor); the network communication I/O interface (115, 125) connects a modem, a server or other network devices having network communication capability through a network cable; the audio I/O Interface (114, 124) connects sound collector (microphone) and/or a speaker; and the USB I/O interface (113, 123) connects an external electronic device. Furthermore, other types of interfaces may be set, for example, a keyboard I/O interface connects a keyboard; a mouse I/O interface connects a mouse.

For example, the permission information that the human-machine operation module 110c has includes control rights of the display I/O interface and the network communication I/O interface. Suppose the user assembles the human-machine operation module 110c on the body 140, when the human-machine operation module 1100 connects the I/O module 111, the I/O module 111 may read the permission information that the human-machine operation module 110c has, and starts the display I/O interface 112 and the network communication I/O interface 115, for the user to operate and use. However, the permission information that the human-machine operation module 110c has only records the control rights of the display I/O interface and the network communication I/O interface, and thus the user cannot use other types of interface functions of the I/O module 111 through the human-machine operation module 110c. Likewise, when the human-machine operation module 1100 is assembled to connect the I/O module 121, the I/O module 111 may only start the display 110 interface 122 and the network communication I/O interface 125.

Also, the permission information that the human-machine operation module 120c has includes control rights of the display I/O interface, the network communication I/O interface and the USB I/O interface. Suppose the user assembles the human-machine operation module 120c on the body 140, when the human-machine operation module 120c connects the I/O module 121, the I/O module 121 may read the permission information that the human-machine operation module 120c has, and starts the display I/O interface 122, the network communication I/O interface 125 and the USB I/O interface 123, for the user to operate and use. However, the permission information that the human-machine operation module 120c has only records the control rights of the display I/O interface, the network communication I/O interface and the USB I/O interface, and thus the user cannot use other types of interface functions of the I/O module 121. through the human-machine operation module 120c. Likewise, when the human-machine operation module 120c is assembled to connect the I/O module 111, the I/O module 111 may only start the display I/O interface 112, the network communication I/O interface 115 and the USB I/O interface 113.

In some embodiments, each of the human-machine operation modules (110c, 120c) store device information, and each I/O module (111, 121) records function information that can be enabled by the device information. When the I/O module (111, 121) connects a target operation module of the human-machine operation modules (110c, 120c), a corresponding function is started according to the device information of the target operation module.

In other embodiments, the hardware connection component 160 may be a regularized design, i.e., the I/O module (111, 121) of the body 140 and its connection joint or connection socket is a regularized design, the human-machine operation modules (110c, 120c) has different corresponding connection joints or connection sockets, and the I/O module (111, 121) may start interfaces which have been successfully connected according to connection conditions.

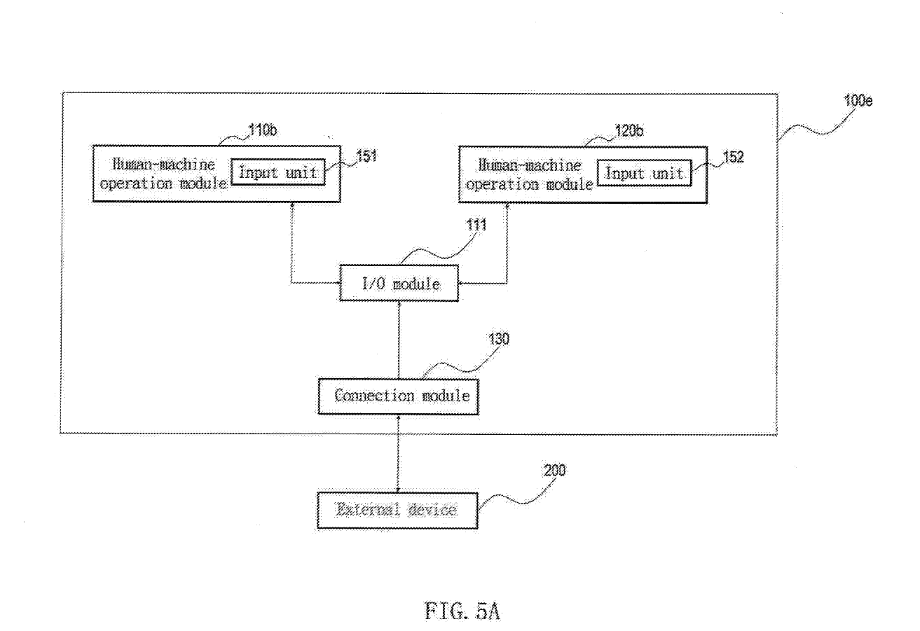

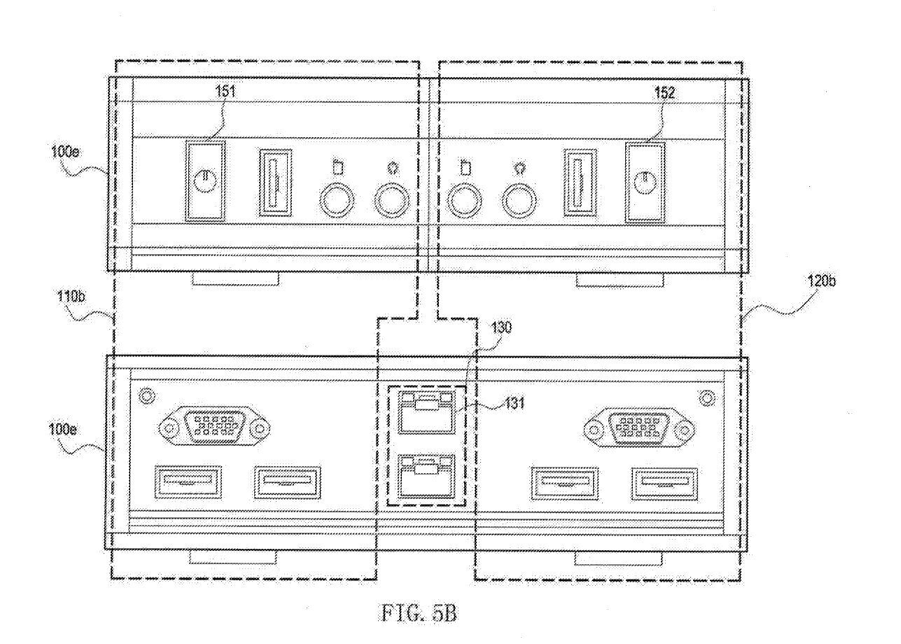

FIG. 5A illustrates a fifth structure block diagram of an embodiment of the electronic device according to the present invention, and FIG. 5B illustrates a third hardware exterior view of an embodiment of the electronic device according to the present invention. The embodiments differ from the previous embodiments in that the electronic device 100e further includes a connection module 130. The connection module 130 internally connects each I/O module, for example, the single I/O module 111 disclosed in FIG. 1A and FIG. 2A, and multiple I/O modules (111, 121) disclosed in FIG. 3 and FIG. 4. The connection module 130 externally connects more than one external device 200. When interfaces of each of the I/O modules (111, 141) operate, they perform message input and output operations with the external device 200 through the connection module 130.

For example, the connection module 130 includes one or more connection ports 131. The external device 200 is connected to one of the single one or more connection ports 131. When the connection module 130 obtains an external message output by any one I/O modules (111, 121), it may analyze the message, and then transmit the message to the external device 200 according to at least one of the address of the external device 200, the name of the external device 200 and the number of the connection ports connected with the external device 200 included in the message. The type of the connection module 130 may include: a network transmission device having capability of transmitting network data such as a network hub, a router, or a network switch, or may be a device having capability of transmitting serial data such as a USB-Hub or a serial port Hub.

In addition, when the connection module 130 is a network transmission device having capability of transmitting network data, for example, a router, the administrator may, as required, make similar or dissimilar domain settings on the human-machine operation modules (110b, 120b) of the electronic device 100e, to make the plurality of human-machine operation modules (110b, 120b) located in the same internal domain, or grouped and located in different internal domains.

However, the I/O modules (111, 121) may connect the connection module 130 by means of network connection or serial bus connection or universal serial bus connection.

In other embodiments, the connection manner in Which the connection module 130 connects the I/O modules (111, 121) is the same as or different from the connection manner in which the connection module 130 connects the external device 200. For example, (1) the connection module 130 connects the I/O Modules (111, 121) by means of network connection, and also connects the external device 200 by means of network connection; (2) the connection module 130 connects the I/O modules (111, 121) by means of USB connection, and also connects the external device 200 by means of USB connection; (3) the connection module 130 connects the I/O modules (111, 121) by means of USB connection, but connects the external device 200 by means of network connection. The connection manner is not limited, and the same or similar connection manners are also applicable.

The above merely describes embodiments of technical measures employed by the present invention for solving the problem, but is not to limit the scope of implementation of the present invention. Equivalent variations and modifications consistent with the literal meaning of the claims of the present invention or made according to the scope of the present invention should fall within the scope of the present invention.

What is claimed is:

1. An electronic device having a plurality of human-machine operation modules, comprising:
at least one I/O module, disposed in the electronic device; and
a plurality of human-machine operation modules, wherein each human-machine operation module is disposed in the electronic device, and several human-machine operation modules are connected with the at least one I/O module respectively.

2. The electronic device having a plurality of human-machine operation modules according to claim 1, wherein, when an input unit of a target operation module of the human-machine operation modules is operated, the target operation module is started.

3. The electronic device having a plurality of human-machine operation modules according to claim 2, wherein the input unit is a switch, and when the switch of the target operation module is turned on, the target operation module is started.

4. The electronic device having a plurality of human-machine operation modules according to claim 2, wherein the input unit is at least one of an electronic authentication device, a remote control, a mouse, a keyboard and a touch screen, and when at least one of the electronic authentication device, the remote control, the mouse, the keyboard and the touch screen is operated in a specific manner, the target operation module is started.

5. The electronic device having a plurality of human-machine operation modules according to claim 4, wherein the electronic authentication device is at least one of a card reader, a fingerprint reader, a voiceprint machine, and a chip authentication device.

6. The electronic device having a plurality of human-machine operation modules according to claim 2, wherein the electronic authentication device further comprises a power control unit, and when the input unit of the target operation module is operated, the target operation module is powered by the power control unit and is started.

7. The electronic device having a plurality of human-machine operation modules according to claim 1, wherein the at least one I/O module is a single I/O module, the human-machine operation modules are connected to the single I/O module, and the single I/O module processes message input and output operations of a target operation module, which has been started, of the human-machine operation modules.

8. The electronic device having a plurality of human-machine operation modules according to claim 1, wherein the at least one I/O module is multiple I/O modules, each human-machine operation module connects one of the multiple I/O modules, and each I/O module processes message input and output operations of the human-machine operation module connected thereto.

9. The electronic device having a plurality of human-machine operation modules according to claim 1, wherein operation panel configurations rendered by the human-machine operation modules are the same or different.

10. The electronic device having a plurality of human-machine operation modules according to claim 1, wherein the human-machine operation modules are capable of being mounted to or removed from the body of the electronic device.

11. The electronic device having a plurality of human-machine operation modules according to claim 10, wherein each of the human-machine operation modules stores permission information, and when the at least one I/O module connects a target operation module of the human-machine operation modules, a corresponding function is started according to interface information of the target operation module.

12. The electronic device having a plurality of human-machine operation modules according to claim 10, wherein each of the human-machine operation modules stores device information, and when the at least one I/O module connects a target operation module of the human-machine operation modules, a corresponding function is started according to interface information of the target operation module.

13. The electronic device having a plurality of human-machine operation modules according to claim 10, wherein the human-machine operation modules have dissimilar hardware connection components, and when the at least one I/O module connects a target operation module of the human-machine operation modules, the at least one I/O module starts interfaces of the hardware connection components.

14. The electronic device having a plurality of human-machine operation modules according to claim 10, wherein the body of the electronic device comprises a power control unit, and when one of the human-machine operation modules is mounted to the body of the electronic device, the power control unit is connected with one of the human-machine operation modules.

15. The electronic device having a plurality of human-machine operation modules according to claim 1, further comprising a connection module, wherein each I/O interface, through the connection module, performs message input and output operations with an external device connected with the connection module.

16. The electronic device having a plurality of human-machine operation modules according to claim 15, wherein the connection module comprises one or a plurality of connection ports, the external device is connected to one of the one or the plurality of connection ports, and the connection module analyzes a message transmitted by each I/O module, and transmits the message to the external device according to at least one of the address of the external device, the name of the external device and the number of the one or the plurality of connection ports connected with the external device included in the message.

17. The electronic device having a plurality of human-machine operation modules according to claim 15, wherein the at least one I/O module connects the connection module by means of network connection, and the network connection comprises wired, wireless, optic fiber and other transmission manners.

18. The electronic device having a plurality of human-machine operation modules according to claim 15, wherein the at least one I/O module connects the connection module by means of serial bus connection or universal serial bus connection.

19. The electronic device having a plurality of human-machine operation modules according to clam 15, wherein the connection manner in which the connection module connects the at least one I/O module is the same as or different from the connection manner in which the connection module connects the external device.
